(19) United States
(12) Patent Application Publication
(10) Pub. No.: US 2018/0080908 A1
(43) Pub. Date: Mar. 22, 2018

(54) INJECTION VALVE ASSEMBLY WITH LOOPING INTERNAL SAMPLE LOOP

(71) Applicant: Neil R. Picha, Claremont, CA (US)

(72) Inventor: Neil R. Picha, Claremont, CA (US)

(21) Appl. No.: 15/496,956

(22) Filed: Apr. 25, 2017

Related U.S. Application Data
(60) Provisional application No. 62/398,460, filed on Sep. 22, 2016.

(51) Int. Cl. G01N 30/20; F16K 31/04

(52) U.S. Cl. CPC G01N 30/20; F16K 31/041; G01N 2030/207; G01N 2030/202; G01N 2030/201

(57) ABSTRACT

An injection valve assembly with looping internal sample loop works to inject discrete fluid samples into analytical instrumentation. The assembly provides an internal sample loop that carries the fluid sample follows an outwardly looping path. This looping deposition enables internal sample loop to have a uniform cross section and a larger sample volume of fluid; thereby creating enhanced peak shape in chromatography readings. The assembly provides a stator defined by stator openings, and a rotor defined by rotor grooves. The rotor grooves are arranged to form a rotor circumference. A stator face engages the stator to maintain operational engagement between the stator and the rotor. Internal sample loop is defined by a generally looped shape and an inner tube diameter. Internal sample loop follows a path at least partially outside the rotor circumference; whereby more than half of the length of internal sample loop is outside the rotor circumference.

### CROSS-REFERENCE TO RELATED APPLICATIONS

This application claims the benefits of U.S. provisional application No. 62/398,460, filed Sep. 22, 2016 and entitled INTERNAL LOOP INJECTION VALVE, which provisional application is incorporated by reference herein in its entirety.

### FIELD OF THE INVENTION

The present invention relates generally to an injection valve assembly with looping internal sample loop. More so, the present invention relates to a biological injection valve assembly that injects fluid samples into analytical instrumentation; whereby the assembly provides a stator and a rotor having a plurality of rotor grooves that form a rotor circumference; whereby a stator face operably couples the stator to the rotor; whereby an internal sample loop carries a fluid sample for injection into the instrumentation; whereby the internal sample loop follows a path at least partially outside the rotor circumference; whereby more than half of the length of the internal sample loop is disposed outside the rotor circumference so as to produce a uniform cross section and a larger sample volume for injection.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, liquid chromatography is a scientific technique for the separation and analysis of complex mixtures of organic and inorganic compounds. The analyte mixture is separated into its components by eluting them from a column having a sorbent by means of moving liquid.

It is known that there are multiple types of injection systems for placing a sample at the inlet end of a separation column in the chromatography. Often, a mechanical valve can be used. The mechanical valve is controlled to intermittently communicate a sample stream with the analytical column as a sample plug. These injection valves direct the movement or flow of fluid into and out of a number of components. Rotary shear valves are commonly used to direct fluid flow in such applications.

It is recognized by those in the art that the prior art injection valves have significant limitations in terms of their minimum injection volume. Known mechanical valves also have shortcomings in terms of mechanical wear and contamination of the sample stream caused by the presence of lubricants and other impurities within the valve.

Often, an internal sample loop is embedded in the stator face and is used to carry the fluid sample to the column. The internal sample loop must be sized to have a fixed volume, so as to have a large enough injection volume to enable sufficient fluid sample to reach the column. Also, the internal sample loop cannot interfere with the rotor and stator seals, or leakage may occur.

Other proposals have involved injection valves for high pressure analytical instrumentation. The problem with these injection devices is that they do not provide an internal sample loop with a large enough cross sectional area. Also, the internal sample loop interferes with the rotor and stator seal. Even though the above cited injection valves meet some of the needs of the market, an injection valve assembly with looping internal sample loop works to inject discrete fluid samples into analytical instrumentation, and an internal sample loop that carries the fluid sample while following an outwardly looping path; whereby the looping deposition enables the internal sample loop to have a uniform cross section and a larger sample volume of fluid, so as to create enhanced peak shape in chromatography readings is still desired.

### SUMMARY

Illustrative embodiments of the disclosure are generally directed to an injection valve assembly with looping internal sample loop. The injection valve assembly injects discrete fluid samples into high pressure analytical instrumentation, such as chromatography and other biological instrumentation. The assembly is unique in that an internal sample loop that carries the fluid sample follows a looped, outwardly disposed path. The path lies substantially outside of the circumference formed by rotor grooves in a rotor.

The outward, looped path enables the internal sample loop to have a uniform cross-sectional area; and thereby carry greater volumes of fluid in a compact region in the assembly. This capacity to carry greater volumes of fluid is possible because of the looped, outwardly disposed configuration of the internal sample loop. Also, the internal sample loop is disposed in the looped path, so as to minimize interference with a seal between the rotor and stator.

In one embodiment, the injection valve assembly provides a stator defined by a plurality of stator openings that enable passage of fasteners for operative coupling with a rotor. The rotor is configured to rotate relative to the stator. The stator and the rotor work together to displace the fluid through the orifices, and into the instrumentation at high pressures. A motor and a shaft work to rotate the rotor.

The rotor is defined by a plurality of rotor grooves that enable free, yet controllable flow of the fluid sample during injection into the analytical instrumentation. The rotor grooves are arranged in a generally circular pattern that forms a rotor circumference.

The injection valve assembly further provides an internal sample loop to carry a sample fluid for injection into instrumentation. The internal sample loop is disposed between the stator and the rotor, and specifically embedded in a stator outer surface of the stator. The internal sample loop is defined by a generally looped disposition that follows a path that lies at least partially outside the rotor circumference.

The looped path of the internal sample loop lies outside the circumferences formed by the rotor grooves. In one embodiment, more than half of the length of the internal sample loop lies outside the rotor circumference. The looped path allows the internal sample loop to form a smaller cross-sectional area than had the internal sample loop followed a path inside the circumference of the rotor grooves, as taught in the prior art.

Thus, the outwardly looping internal sample loop enables a larger volume of fluid to be contained in the internal sample loop, and thereby injected into the instrumentation. The looping disposition of the internal sample loop produces a uniform cross section and a larger sample volume of fluid; thereby creating enhanced peak shape in chromatography readings due to more uniform sweeping of the sample fluid through the internal sample loop. This results in more enhanced injection of the fluid into the analytical instrumentation. Further, a seal portion is operational between the stator and rotor helps minimize leakage of fluid sample.

One aspect of an injection valve assembly, comprises:
a stator defined by a stator outer surface forming a plurality of stator openings;
a rotor defined by a plurality of rotor grooves, the plurality of rotor grooves arranged to form a rotor circumference, the rotor configured to rotate to at least two discrete rotary positions;
a stator face configured to engage the stator, the stator face configured to help maintain operational engagement between the stator and the rotor, the stator face defined by a plurality of fluid holes;
a seal portion disposed between the stator and the rotor, the seal portion configured to help inhibit leakage between the stator and the rotor;
an internal sample loop defined by a generally looped shape and an inner tube diameter, the internal sample loop embedded in the stator outer surface, the internal sample loop configured to follow a path at least partially outside the rotor circumference,
whereby more than half of the length of the internal sample loops is disposed outside the rotor circumference;
a motor operatively engaging the rotor, the motor configured to rotate the rotor to the at least two discrete rotary positions; and
a shaft configured to join the motor to the rotor, the shaft concentrically disposed to the rotor.

In another aspect, the stator is fixed in relation to the rotor.

In another aspect, the stator is defined by a stator outer surface disposed to engage the rotor.

In another aspect, the rotor is configured to selectively rotate to two discrete rotary positions.

In another aspect, the rotor is configured to selectively rotate to three discrete rotary positions.

In another aspect, the internal sample loop is embedded in the stator outer surface.

In another aspect, the inner tube diameter of the internal sample loop is about 0.015 inches.

In another aspect, the internal sample loop is configured to contain more than two microliters of a fluid.

In another aspect, the internal sample loop is configured to contain about five microliters of the fluid.

In another aspect, the seal portion comprises a resilient panel.

In another aspect, the stator face comprises a plurality of fluid holes that are configured to enable passage of a fluid to the stator outer surface.

In another aspect, is one, two, or more sample loops internal to the valve.

In another aspect, the motor is an electrical motor.

In another aspect, the assembly is configured to inject a sample fluid into an instrumentation.

One objective of the present invention is to enhance the cross section of injection fluid in an internal sample loop.

Another objective is to loop the internal sample loop so that at least half of the length of the internal sample loop lies outside the rotor circumference.

Another objective is to loop the internal sample loop so that at least 80% of the length of the internal sample loop lies outside the rotor circumference.

Another objective is to increase the volume of fluid sample contained in the internal sample loop.

Yet another objective is to provide an internal sample loop that maintains a seal in the seal portion.

Yet another objective is to provide enhanced peak shape in chromatography due to more uniform sweeping of a sample fluid being injected from the large cross sectional area of the internal sample loop.

Yet another objective is to eliminate tools and fasteners associated with fitting an internal sample loop to an injector valve.

Yet another objective is to provide an inexpensive to manufacture injection valve assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary injection valve assembly with looping internal sample loop, in accordance with an embodiment of the present invention;

FIGS. 2A and 2B illustrate perspective views of an exemplary stator, where FIG. 2A is a rear view showing an exemplary rotor engaged with the stator, and FIG. 2B is a frontal view showing an exemplary stator face, in accordance with an embodiment of the present invention;

FIG. 3 illustrates a front sectioned view of the stator shown in FIG. 2A, in accordance with an embodiment of the present invention;

FIGS. 4A and 4B illustrate perspective views of an exemplary rotor, where FIG. 4A is a rear view showing the rotor, and FIG. 4B is a frontal view showing the rotor having a plurality of rotor grooves, in accordance with an embodiment of the present invention;

FIG. 5 illustrates a front perspective view of an exemplary stator face, in accordance with an embodiment of the present invention;

FIG. 6 illustrates a front view of opposite sides of the stator face with an exemplary internal sample loop looping outside the rotor circumference, in accordance with an embodiment of the present invention;

FIG. 7 illustrates a sectioned side view of the stator face and internal sample loop, the section taken along section A-A of FIG. 6, detailing the path of the internal sample loop, in accordance with an embodiment of the present invention;

FIG. 8 illustrates a front perspective view of a rotor and a stator, in accordance with an embodiment of the present invention;

FIG. 9 illustrates a rear perspective view of a rotor, detailing the rotor grooves and an outwardly disposed, looped path of an internal sample loop, in accordance with an embodiment of the present invention;

FIG. 10 illustrates a top view of an exemplary chromatography valves use an external loop in a second discrete position, in accordance with an embodiment of the present invention;

FIG. 11 illustrates a top view of an exemplary chromatography valves use an external loop in a first discrete position, in accordance with an embodiment of the present invention;

FIG. 12 illustrates a prior art internal loop, showing the loop is filled with a sample fluid through a syringe and excess fluid goes to waste, the rotor grooves rotates, and the loop is spliced into the flow path of the sample fluid, in accordance with an embodiment of the present invention;

FIGS. 13A and 13B illustrate a front face view of an exemplary internal sample loop embedded in a stator seal, where FIG. 13A shows an internally disposed internal sample loop, and FIG. 13B shows a rotor rotating around the tube, in accordance with an embodiment of the present invention;

FIG. 14 illustrates the more constricted flow path of an inner loop, in accordance with an embodiment of the present invention;

FIG. 15 shows the wider flow path of an inner loop, in accordance with an embodiment of the prior art;

FIG. 16 illustrates a front face view of an exemplary sealing area for internal loop, in accordance with an embodiment of the present invention;

FIG. 17 illustrates the sealing area between the stator outer face and the stator, in accordance with an embodiment of the present invention; and

FIG. 18 illustrates a side view of sealing area as being substantially the same between the inner stator face and the stator, as it is between the rotor and the stator seal, in accordance with an embodiment of the present invention.

Like reference numerals refer to like parts throughout the various views of the drawings.

### DETAILED DESCRIPTION OF THE INVENTION

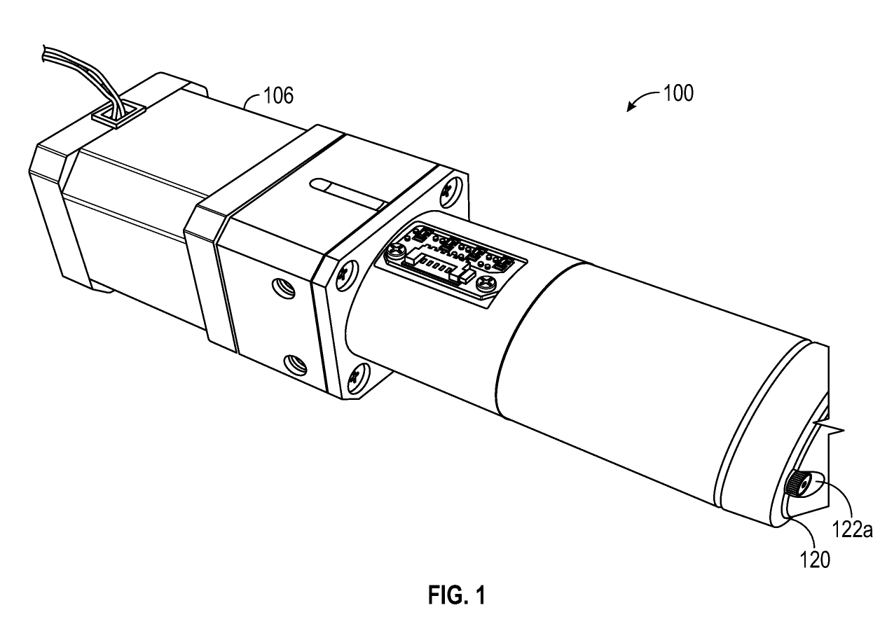

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Illustrative embodiments of the disclosure are generally directed to an injection valve assembly 100 with internal sample loop, as referenced in FIGS. 1-17. The injection valve assembly 100 with looping internal sample loop, hereafter “assembly 100”, works to inject discrete fluid samples into high pressure analytical instrumentation.

The assembly 100 is unique in that an internal sample loop 126 that carries the fluid sample follows an outwardly disposed, looped path 132 that enables the internal sample loop 126 to have a uniform cross section and a large sample volume of fluid. This configuration allows sufficient fluid to be injected into the instrumentation, so as to achieve an enhanced peak shape in chromatography readings, due to the more uniform sweeping of the sample fluid through the internal sample loop 126. Also, the internal sample loop 126 is disposed in the looped path 132, so as to minimize interference with a seal portion 134 of the assembly 100.

Looking at FIG. 1, the assembly 100 may operate substantially the same as an injection valve known in the art. The assembly 100 controllably discharges a sample fluid into analytical instrumentation. For example, the assembly 100 may inject discrete fluid samples into high pressure analytical instrumentation, such as chromatography, HPLC, and other biological instrumentation. Though in some embodiments, the assembly 100 may also inject fluid into varies types and sizes of mechanisms, due to the scalable configuration of the assembly 100.

The assembly 100 is unique in that an internal sample loop 126 that carries the fluid sample follows an outwardly looping path 132, relative to a rotor circumference 124 that is formed by rotor grooves 114a-h that form in a rotor 112. In this manner, a substantial portion of the length of the internal sample loop 126 lies outside the rotor circumference 124. This is significant because the looped path 132 enables the internal sample loop 126 to have a small cross-sectional area. The small cross-sectional area allows the internal sample loop 126 to carry greater volumes of fluid than the prior art internal sample loops that resided substantially inside a smaller circumferential area inside the rotor circumference 124. The smaller cross-sectional area, and thus the increased capacity to carry fluid volume is possible because of the looped disposition of the internal sample loop 126, outside the rotor circumference 124; and thereby follows a longer path.

Those skilled in the art will recognize that analytical instrumentation used to determine chemical composition of samples commonly utilizes injection, switching and selector valves to perform routine fluid switching and injection of samples into pressurized fluid streams. These valves direct the movement or flow of fluid into and out of a number of components. Rotary shear valves are commonly used to direct fluid flow in such applications.

It is also known that a flat face shear valve with internal loop is commonly used to inject a fixed volume of fluid into such analytical instrumentation. There are, however, limitations in sample size due to the design and construction of these valves, and common design practices that are understood to be necessary to seal the assembly 100. Thus, the looped path 132 followed by the internal sample loop 126 is configured to minimize interference between the internal sample loop 126 and a seal portion 134 that lies between a rotor 112 and a stator 102 in the assembly 100.

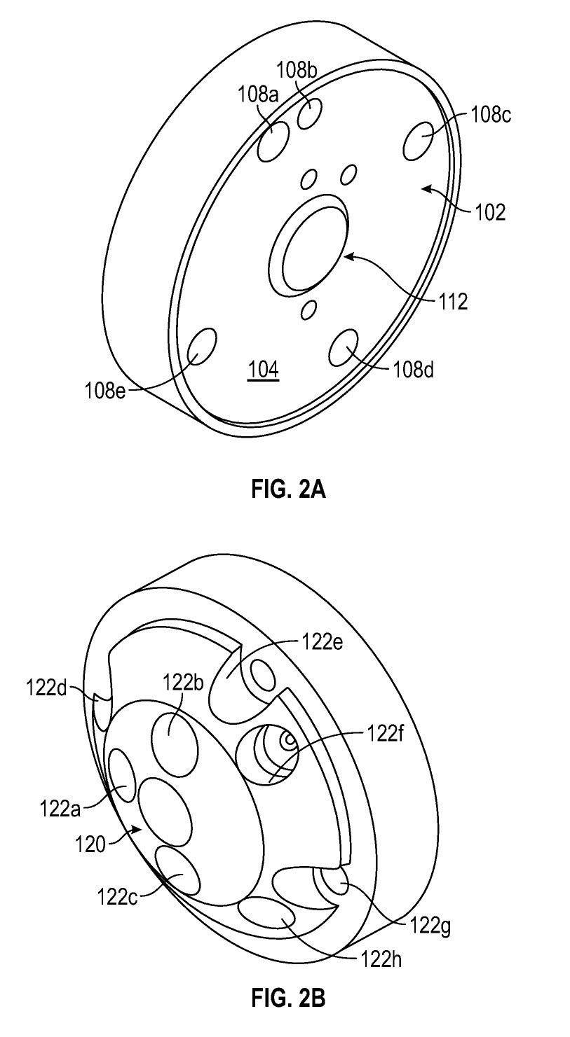

Turning to FIG. 2A, the assembly 100 provides a stator 102 and a rotor 112 that work together to create the necessary flow path to controllably inject a fluid through a plurality of rotor grooves 114a-h, before finally being injected into the instrumentation. The stator 102 is fixed in relation to the rotor 112.

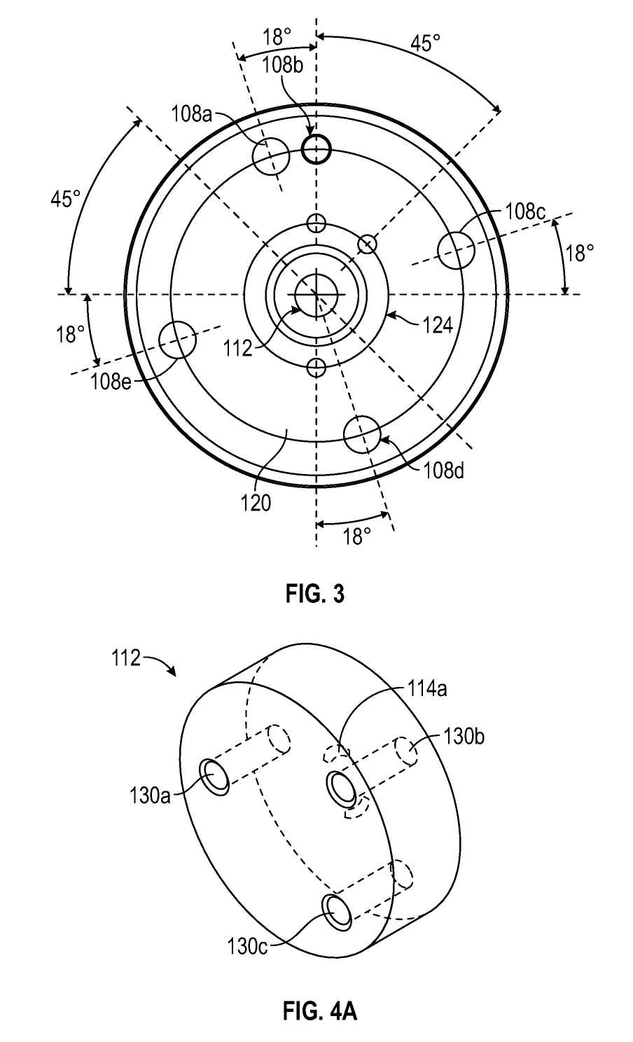

As illustrated in FIG. 2B, the stator 102 is defined by a stator 102 outer surface having a generally flat, round shape. A plurality of stator openings 108a-e form in the stator 102 outer surface to enable a fluid to flow between the stator 102 to the rotor 112. In some embodiments, the stator openings 108a-e may be arranged in a generally circular pattern. In one embodiment, five stator openings 108a-e are disposed in a spaced-apart, concentric relationship (FIG. 3).

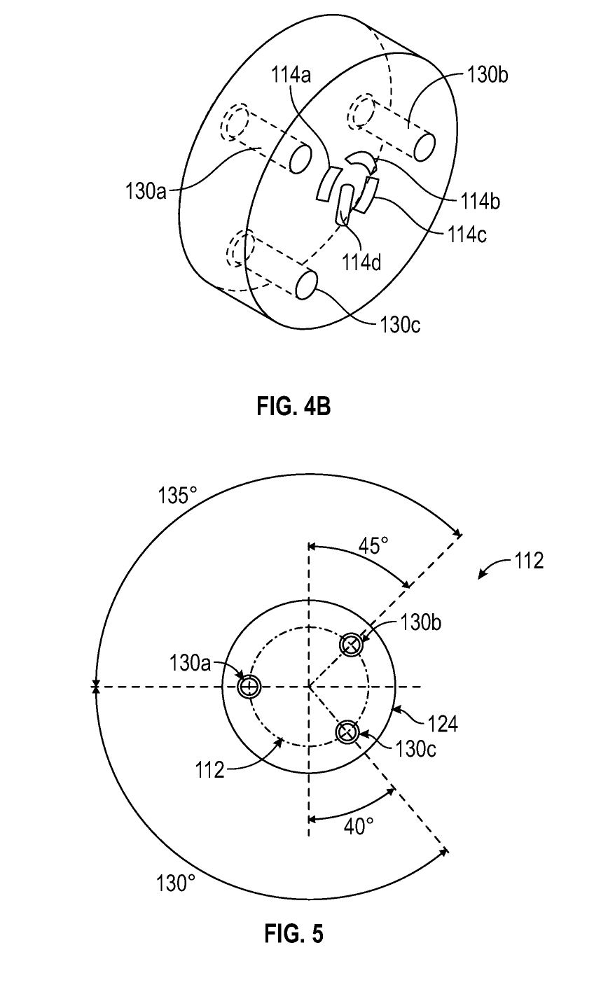

As referenced in FIGS. 4A and 4B, the rotor 112 is defined by a plurality of rotor grooves 114a-h that enable free, yet controllable flow of the fluid during injection into the analytical instrumentation. In one embodiment, the rotor grooves 114a-h are small holes disposed in a spaced-apart, circular arrangement. Though in other embodiments, the rotor grooves 114a-h may be elongated and have different width openings.

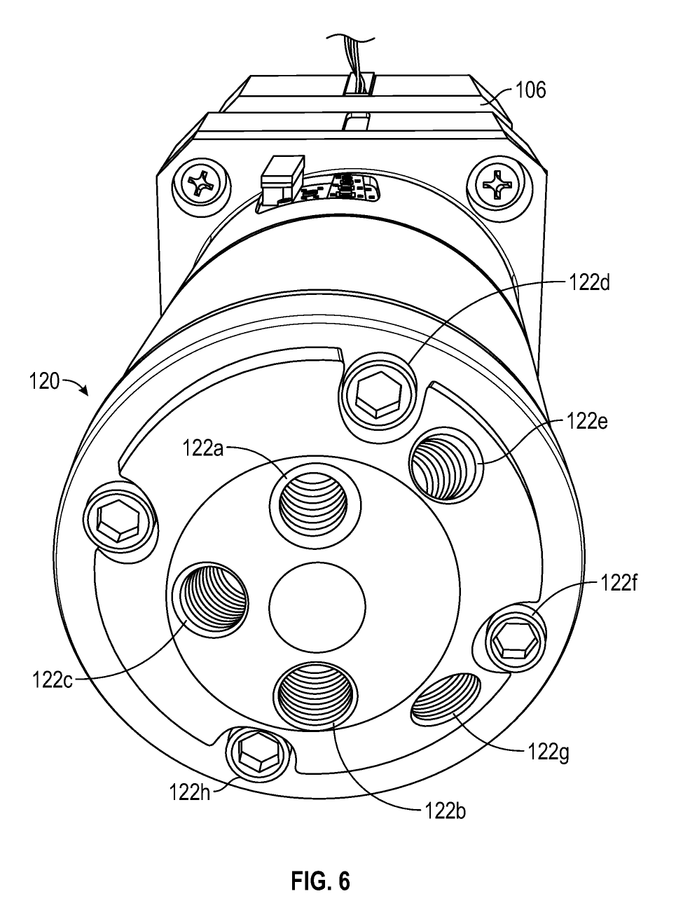

The generally circular pattern of the rotor grooves 114a-h is defined by a rotor circumference 124, shown in FIG. 6. The rotor circumference 124 is the outer periphery of the rotor grooves 114a-h. Though in some embodiments, at least one rotor groove 114h may form outside the general rotor circumference 124. This outlier rotor groove may be necessary to achieve a pattern that produces a desired injection distribution of the fluid sample.

In one embodiment, the rotor 112 is further defined by three holes 130a, 130b, 130c disposed in an equally-spaced arrangement and configured to help fasten the rotor 112 to the shaft. A fastener, such as a dowel pin, may pass through the holes 130a-c. The holes 130a-c may be effective for retaining the rotor 112 in one of the at least two rotary positions, as described below.

Looking now at FIG. 5, the assembly 100 may further include a stator face 120 that is configured to at least partially engage the stator 102. In one embodiment, the stator face 120 has a generally cylindrical shape. The stator face 120 forms a surface and coupling ports that retains the stator 102 in place relative to the rotor 112. In this manner, the stator face 120 helps maintain operational engagement between the stator 102 and the rotor 112. The stator face 120 is defined by a plurality of fluid holes 122a-h. In one embodiment, five fluid holes 122a-h form in the stator face 120. The stator 102 and the stator face 120 are static.

The rotational component of the assembly 100 is used to align the internal sample loop with a column to load fluid sample into the internal sample loop 126. For example, the stator face 120 locks the stator 102 and rotor 112 into an operational position. Also, the rotor 112 is configured to rotate at least two discrete rotary positions. In one embodiment, the rotor 112 rotates three discrete rotary positions. In this manner, the rotor grooves 114a-h may be selectively rotated to communicate with respective openings, holes, and ports; and thereby enable free flow of the fluid for injection. The holes 130a-c enable passage of dowel pins to retain the rotor 112 in one of the two rotary positions.

In one exemplary rotational manipulation of the rotor 112, the rotor 112 has two rotary positions. In a first rotary position the sample inlet is connected to one end of the sample loop so that the latter is filled with sample fluid. In the second rotary position the sample inlet is normally connected to the waste collector for disposal of the remaining sample that is not required. At the same time, in the second rotary position the sample loop is switched between the inlet for the mobile phase and the outlet leading to the column. This second rotary position of the rotor 112 thus corresponds to the sample injection phase, in which the quantity of sample measured into the internal sample loop 126 is transported to the column.

Turning now to FIG. 6, the assembly 100 provides an internal sample loop 126 that is sized and dimensioned to store the fluid that is to be injected into the analytical instrumentation. In one embodiment, the fluid is methanol or other polar solvent known in the art of chromatography and biological instrumentation. The internal sample loop 126 is lies in a generally small area between the stator 102 and the rotor 112. In one embodiment, the internal sample loop 126 is embedded in the stator outer surface 104, or in a seal portion 134.

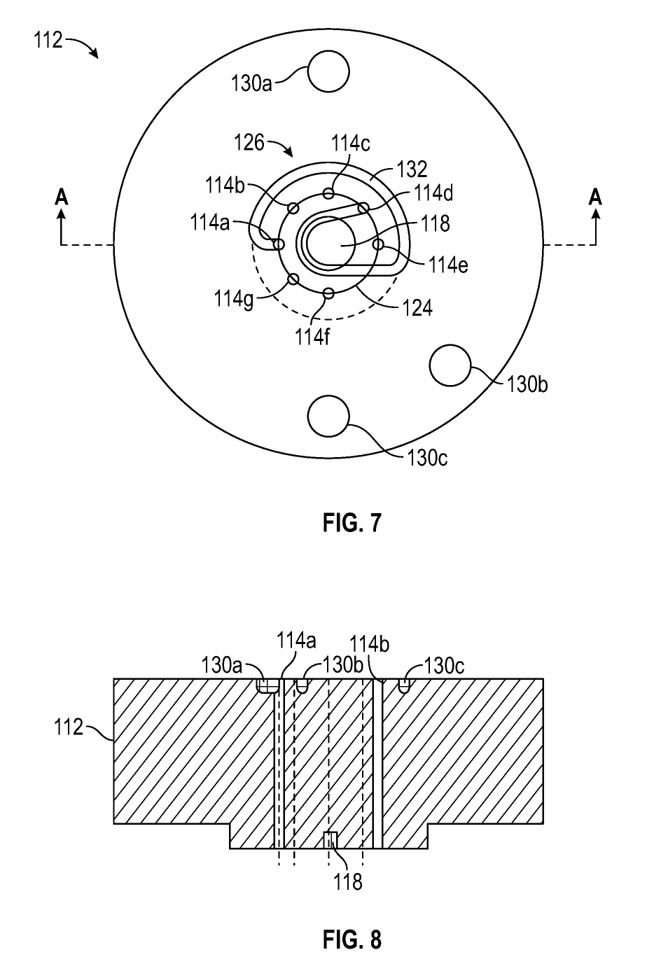

Those skilled in the art will recognize that a stator for a biological or chromatography valve is generally small, and leaves little space for tubing to carry the fluid. FIG. 7 highlights a sectioned view of the rotor 112, illustrating the limited size for the internal sample loop 126 to operate therein. Thus, the disposition of the present internal sample loop 126 optimizes the available space by following an outwardly looping path 132.

The internal sample loop 126 is defined by a generally looped shape. The internal sample loop 126 is also defined by an inner tube diameter 110 that carries a fixed volume of fluid. In one embodiment, the inner tube diameter 110 is about 0.015″. Though in other embodiments, other diameter sizes for the internal sample loop 126 may be used. The internal sample loop 126 generally follows a path 132 that is at least partially outside the stator 102 circumference, or the rotor circumference 124, or both. In one embodiment, the internal sample loop 126 may be bent to achieve a desired path 132.

As shown in FIG. 6, a first end of the internal sample loop 126 terminates at one of the rotor grooves 114d, and then loops around the rotor circumference 124 of multiple rotor grooves 114b-e, before a second end of the internal sample loop 126 extends into the circumferential area and finally terminating at an oppositely disposed rotor groove 114a. FIG. 8 shows a frontal perspective view of the rotor 112 operational with the stator 102. The internal sample loop 126 is not visible in this view because it positions between the rotor 112 and the stator 102, at the rear of the stator face seal surface 118.

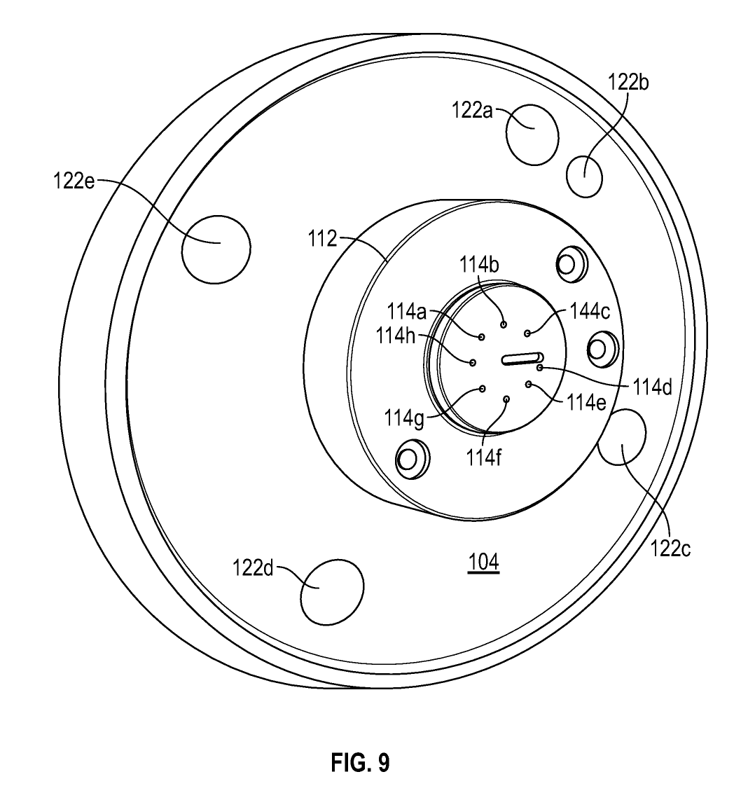

FIG. 9 illustrates yet another possible embodiment of the internal sample loop 126 in which the internal sample loop 126 loops in a path 132 that is substantially outside the circumference of the stator 102 and rotor grooves 114a-h. In one embodiment, at least 80% of the length of the internal sample loop 126 lies outside the rotor circumference 124. In one embodiment, the internal sample loop 126 follows an optimal flow path geometry, with larger, volumes greater than 2 microliters, and an optimal volume of 5 microliters with an inner tube diameter 110 of approximately 015″. Though other dimensions for the internal sample loop 126 may be used in other embodiments.

In yet another embodiment of the internal sample loop 126, the internal sample loop 126 follows a path 132 that is at least partially outside a seal circumference or seal region of the seal portion 134. In any case, the generally looped path 132 taken by the internal sample loop 126 increases the fluid volume of the internal sample loop 126; and thereby enables the internal sample loop 126 to carry greater volumes of fluid while compacted in the generally small area of the stator outer face 104. In essence, The looped path 132 of the internal sample loop 126 outside the circumferences formed by the rotor grooves 114a-h allows the internal sample loop 126 to form a smaller cross-sectional area than had the internal sample loop followed a path inside the circumference of the rotor grooves 114a-h, as taught in the prior art.

The looping disposition of the internal sample loop 126 produces a uniform cross section, a larger sample volume of fluid, and enhanced peak shape of chromatography readings due to more uniform sweeping of the fluid through the internal sample loop 126. This results in more enhanced injection of the fluid into the instrumentation, as a greater quantity of fluid is available for injection into the instrumentation at any one time. Also, the loop size is longer.

In some embodiments, the assembly 100 may further include a seal portion 134 disposed between the stator 102 and the rotor 112. The seal portion 134 helps inhibit leakage between the stator 102 and the rotor 112. In one embodiment, the seal portion 134 is a high performance plastic, such as PEEK. In another embodiment, the internal sample loop 126 lies substantially outside a circumference formed by the seal portion 134. The internal sample loop 126 is disposed to generally not interfere with the seal portion 134 due to the looped path 132. In one embodiment, the seal portion 134 is a stator face seal that is mounted and pinned to the stator 102.

In some embodiments, the assembly 100 may further include a motor 106 operatively engaging the rotor 112. The motor 106 may include an electric motor known in the art of injector valves for analytical instrumentation. The motor 106 works to rotate the rotor 112 to the at least two discrete rotary positions. In another embodiment, a shaft 118 operatively couples between the motor 106 and the rotor 112. The shaft 118 is configured to transmit torque and angular velocity from the motor 106 to the rotor 112. In one embodiment, the shaft 118 is concentrically disposed to the rotor 112, so as to create an efficient arrangement.

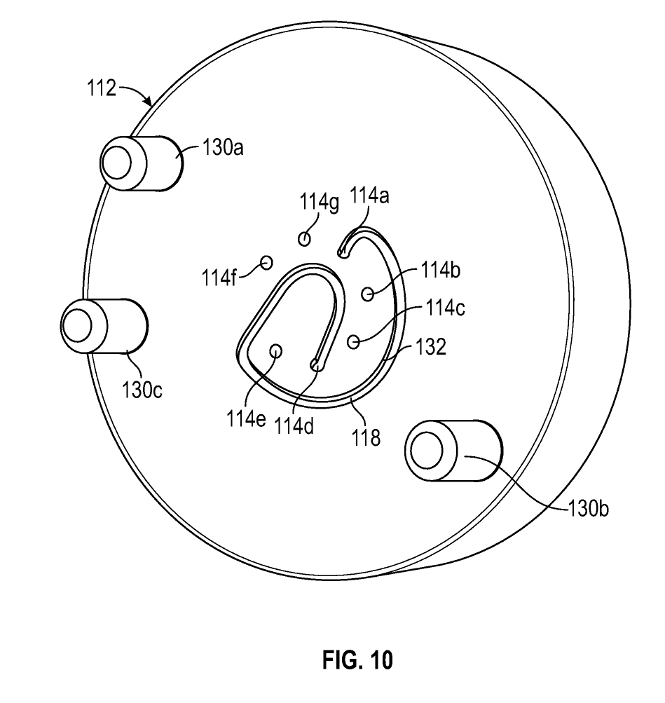

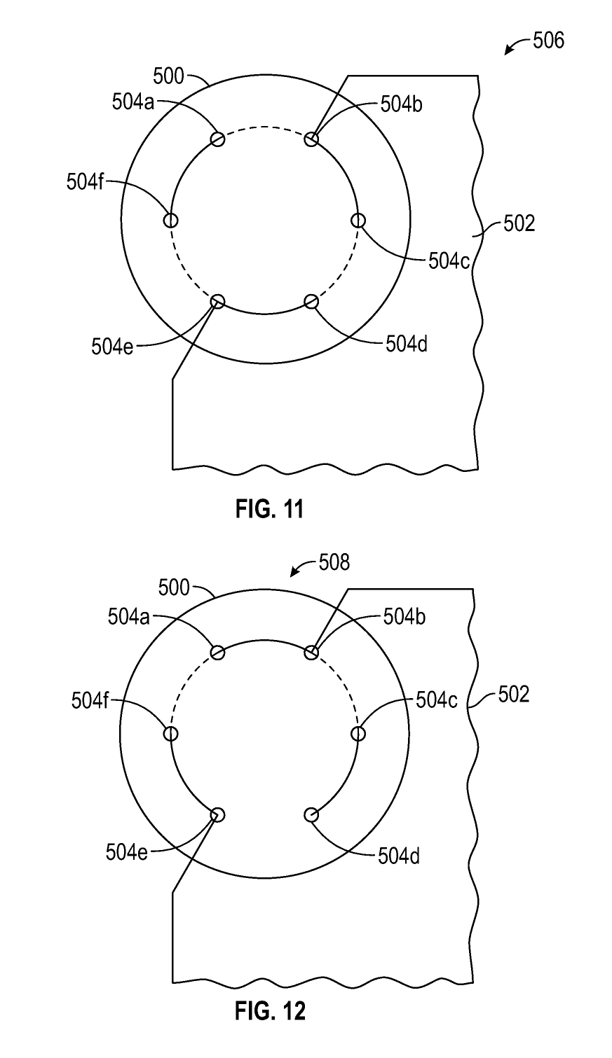

As FIGS. 11 and 12 illustrate, a prior art chromatography injection valve 500 utilizes an external looped tube 502 to hold sample fluid during the injection. With the standard looped tube 502, the injection valve has six ports 504a-f and the loop is a length of tubing with a predetermined volume. The tube 502 is applied to the valve 500 with standard fittings. It is, however, often desired to use an injection valve with an internally positioned tube so as to avoid the external piece of tube and fittings. In this case, the piece of tube is internal to the valve and is usually machined into the stator or stator face seal between the rotor and the stator. FIG. 10 is the valve 500 shown in a first discrete position 506, while FIG. 11 is the valve 500 shown in a second discrete position 508.

When an internally disposed tube is used, a groove or similar feature with discrete volume is used on the back of the stator face seal, between the stator seal and the inner stator face 104. The groove is machined between the fluid orifices in the stator seal. The groove can be in the stator surface or the inner stator face opposite the rotor surface. For the 6 port injector valve, the groove is between the two ports, as shown in FIG. 12.

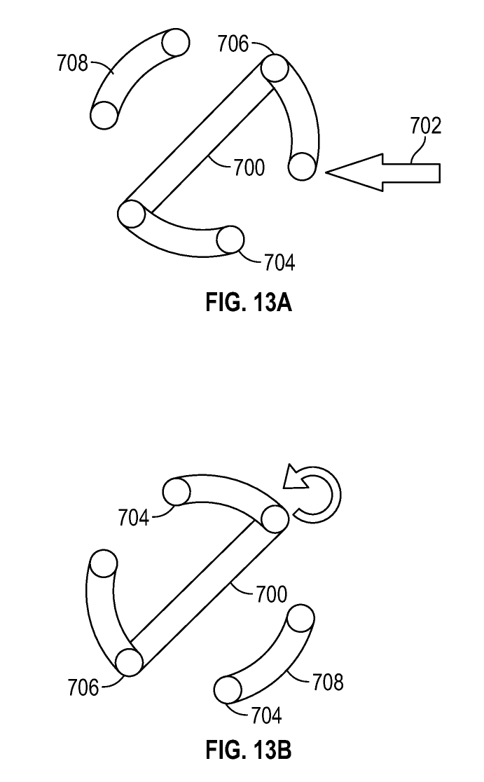

In FIG. 13A, an exemplary prior art valve shows an internally disposed internal sample loop 700 that is filled with a sample fluid through a syringe 702 at an inlet end 706 of the tube 700. The excess fluid is discharged at a waste end 704 of the tube 700. A pump forces the fluid through a column 708 in the chromatography instrument for conditioning. A rotor is configured to rotate, so as to enable the fluid from the tube 700 to flow through the chromatography column 708. In FIG. 13B, it is seen that when a rotor works to rotate the tube 700, the path of the chromatography column 708 is spliced into the flow path of the sample fluid in the tube 700.

Thus, the internal tube 700 of the prior art is a fixed volume because it is machined into the stator seal or the stator. The tube 700 positions between the fluid ports inside the circumference of a circle. Here, the circle comprises six fluid holes that enable passage of sample fluid. The reason the tube 700 is inside the circle is because it is assumed that this is the only way that the flow path can be sealed for the high pressure necessary for high pressure liquid chromatography. In this case, sealing is difficult to attain and requires a strong force to push the seals together. Excessive force, however, creates higher torque, which disrupts rotation of the rotor. Also in the prior art, costs are managed through use of stepper motors.

Comparing the prior art valve 700 with the present disclosure shown in FIG. 13A, an internal sample loop 126 that stores sample fluid for injection. The internal sample loop 126 is embedded in a stator outer face 104 or a stator seal, and is disposed to loop outside the rotor circumference 124 of the rotor grooves 114a-h. This outwardly looping disposition of the internal sample loop 126 forms an internal sample loop 126 having a uniform cross section and a larger sample volume of fluid; thereby creating enhanced peak shape in chromatography readings due to more uniform sweeping of the sample fluid through the internal sample loop 126.

Returning now to the volume restrictions of the prior art internal tube 700; if a larger volume is required in the internal sample tube 700, a cross section larger than the normal flow path or larger than the tubing inner diameter used in the system. So instead of a fixed groove diameter, the flow path opens to a wider channel.

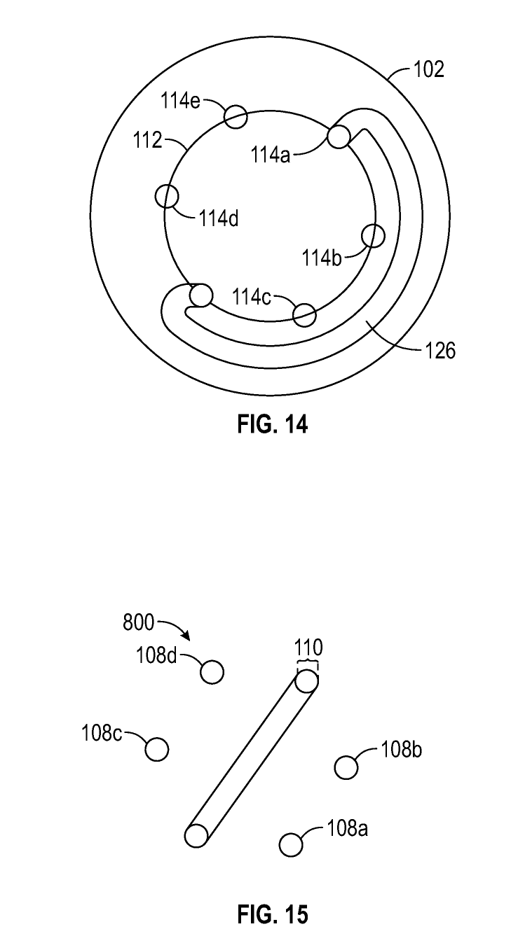

As discussed above, the internal sample loop 126 is defined by an inner tube diameter 110 that carries a fixed volume. FIG. 14 illustrates an example of internal sample loop 800 having a smaller inner tube diameter; and thereby a more constricted flow path. Conversely, FIG. 15 shows a wider flow path in the internal sample loop 802 for increased flow rate of the sample fluid.

Those skilled in the art will recognize however, that the problem with the wider flow path is that with a non-uniform cross section, dispersion is observed, or the normal flow of sample fluid becomes less uniform and the concentration varies. The present internal sample loop 126 solves this problem by maintaining a uniform cross section, and a larger volume due to a larger inner tube diameter outside the rotor circumference. This looping configuration allows the internal sample loop 126 to contain greater amounts of sample fluid.

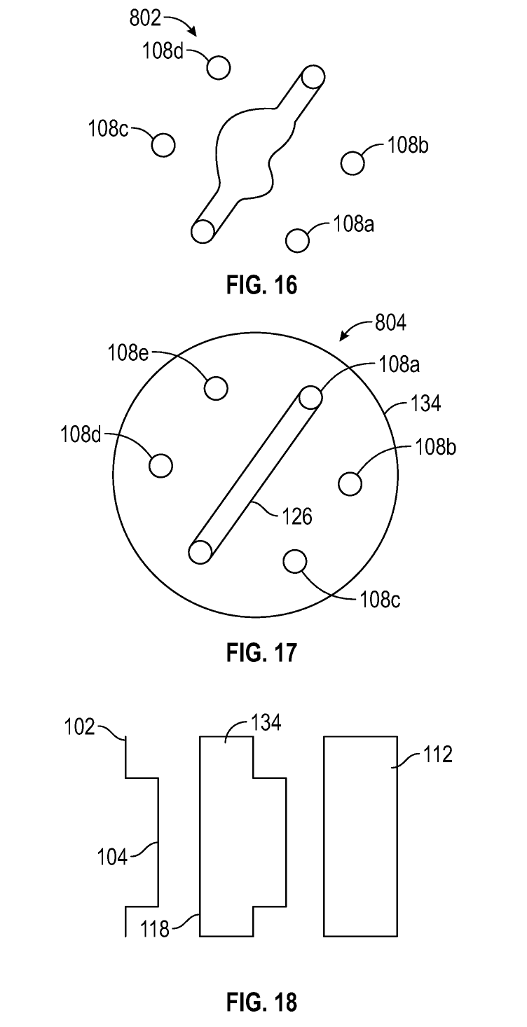

As discussed above, a seal portion 134 helps prevent leakage of fluid between the stator and rotor. The seal portion 134 may, however, be problematic in that it restricts the looping path 132 taken by the internal sample loop 126. Looking at FIG. 16, the seal portion 134 is defined by a general region, or sealing area 804 that restricts leakage in a region of the internal sample loop 126 is illustrated.

As shown in FIGS. 17 and 18, the sealing area 804 is substantially the same between the stator outer face 104 and the stator 102, as it is between the rotor and the stator seal portion 134. This relationship between sealed portion 134, rotor 112, and stator 102 is illustrated in FIG. 17. As shown, the seal geometry is less limited, because the internal sample loop loops outside the sealing area 804 of the seal portion 134.

Those skilled in the art will recognize that flat face shear valves are commonly used for smaller flow rates to inject sample fluids into instrumentation. The flat face shears are limited to lower flow rates because of seal geometry limitations. The sealing area between adjacent ports are usually always at least ½ times the diameter of the port. This is due to tolerance, machine accuracy, motor positioning errors, backlash, and encoder limitations.

This sealing problem is resolved by using internal sample loop, as shown in FIG. 13B. The looping internal sample loop 126 creates a uniform cross section and a larger sample volume. The sample fluid is fluidly swept more efficiently. This type of internal sample loop 126 is not obvious because it would be thought difficult to seal, because it reduces the sealing surface to the outside of the injector valve.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An injection valve assembly, the assembly comprising:
a stator defined by a plurality of stator openings;
a rotor defined by a plurality of rotor grooves, the plurality of rotor grooves arranged to form a rotor circumference, the rotor configured to rotate relative to the stator and the stator face;
a stator face configured to operably couple the stator to the rotor; and
at least one internal sample loop defined by a generally looped shape and an inner tube diameter, the at least one internal sample loop configured to follow a path at least partially outside the rotor circumference,
whereby more than half of the length of the at least one internal sample loop is disposed outside the rotor circumference.

2. The assembly of claim 1, further comprising a motor operatively engaging the rotor, the motor configured to rotate the rotor.

3. The assembly of claim 1, wherein the rotor is configured to selectively rotate to two discrete rotary positions.

4. The assembly of claim 1, wherein the rotor is configured to selectively rotate to at least three discrete rotary positions.

5. The assembly of claim 1, further comprising a shaft configured to join the motor to the rotor, the shaft concentrically disposed to the rotor.

6. The assembly of claim 1, wherein the stator is fixed in relation to the rotor.

7. The assembly of claim 1, wherein the stator is defined by a stator face seal surface and a stator outer surface, the stator outer surface disposed to engage the rotor.

8. The assembly of claim 7, wherein the at least one internal sample loop is embedded in the stator outer surface, or the stator face seal surface.

9. The assembly of claim 1, wherein the at least one internal sample loop is configured to contain more than two microliters of a sample fluid.

10. The assembly of claim 1, wherein the at least one internal sample loop is configured to contain about five microliters of the sample fluid.

11. The assembly of claim 1, further comprising a seal portion disposed between the stator and the rotor, the seal portion configured to help inhibit leakage between the stator and the rotor.

12. An injection valve assembly, the assembly comprising:
a stator defined by a stator outer surface forming a plurality of stator openings;
a rotor defined by a plurality of rotor grooves, the plurality of rotor grooves arranged to form a rotor circumference, the rotor configured to rotate to at least two discrete rotary positions;
a stator face configured to operably couple the stator to the rotor, the stator face defined by a plurality of fluid holes;
a seal portion disposed between the stator and the rotor, the seal portion configured to help inhibit leakage between the stator and the rotor, the seal portion further configured to retain at least one internal sample loop,
whereby the at least one internal sample loop is defined by a generally looped shape and an inner tube diameter, the at least one internal sample loop embedded in the stator outer surface, the at least one internal sample loop configured to follow a path substantially outside the rotor circumference,
whereby more than half of the length of the at least one internal sample loop is disposed outside the rotor circumference;
a motor operatively engaging the rotor, the motor configured to rotate the rotor to the at least two discrete rotary positions; and
a shaft configured to join the motor to the rotor, the shaft concentrically disposed to the rotor.

13. The assembly of claim 12, wherein the rotor is defined by three holes configured to help fasten the rotor to the shaft.

14. The assembly of claim 12, wherein the at least one internal sample loop is defined by an inner tube diameter between 0.005 inches and 0.060 inches.

15. The assembly of claim 12, wherein the at least one internal sample loop is configured to contain about five microliters of a sample fluid.

16. An injection valve assembly with looping internal sample loop, the assembly consisting of:
a stator defined by a stator outer surface forming a plurality of stator openings;
a rotor defined by a plurality of rotor grooves, the plurality of rotor grooves arranged to form a rotor circumference, the rotor configured to rotate to two or three discrete rotary positions;
a stator face configured to operably couple the stator to the rotor, the stator face defined by a plurality of fluid holes;
a seal portion disposed between the stator and the rotor, the seal portion configured to help inhibit leakage between the stator and the rotor, and to contain at least one internal sample loop,
whereby the at least one internal sample loop is defined by a generally looped shape and an inner tube diameter of about 0.015 inches, the at least one internal sample loop embedded in the stator outer surface, the at least one internal sample loop configured to follow a path at least partially outside the rotor circumference,
the at least one internal sample loop further configured to contain about five microliters of a sample fluid,
whereby more than half of the length of the at least one internal sample loop is disposed outside the rotor circumference;
a motor operatively engaging the rotor, the motor configured to rotate the rotor to the at least three discrete rotary positions; and
a shaft configured to join the motor to the rotor, the shaft concentrically disposed to the rotor.
